(19) United States
(12) Patent Application Publication
(10) Pub. No.: US 2015/0088859 A1
(43) Pub. Date: Mar. 26, 2015

(54) CLICK MAGNET IMAGES

(71) Applicants: ANDREAS CHRISTIAN WEISSL, Zurich (CH); Aurelien Boffy, Basel (CH); Randall G. Keller, Palo Alto, CA (US); Alexandra Zykova, Zurich (CH); Michihiro Kuramochi, Palo Alto, CA (US)

(72) Inventors: ANDREAS CHRISTIAN WEISSL, Zurich (CH); Aurelien Boffy, Basel (CH); Randall G. Keller, Palo Alto, CA (US); Alexandra Zykova, Zurich (CH); Michihiro Kuramochi, Palo Alto, CA (US)

(73) Assignee: Google Inc.

(21) Appl. No.: 13/529,563

(22) Filed: Jun. 21, 2012

(51) Int. Cl. G06F 17/30

(52) U.S. Cl. 707/722; 707/E17.014

(57) ABSTRACT

Methods, systems, and apparatus, including computer programs encoded on a computer storage medium, for identifying click magnet images. In one aspect, a method includes obtaining selections vector for images. A selection vector for an image can include vector elements that correspond to a unique search query. The value of each vector element can be proportional to a number of selections of image search results that included a representation of the image when the search results were presented in response to the unique search query. The image can be deemed be a click magnet image based at least in part on a first number of selections of image search results that included a representation of the image for search queries categorized as belonging to a set of categories and a total number of selections of image search results that included a representation of the image.

### BACKGROUND

This specification relates to classifying images for information retrieval.

The Internet provides access to a wide variety of resources, such as image files, audio files, video files, and web pages. A search system can identify resources in response to a text query that includes one or more search terms or phrases. The search system ranks the resources and provides search results that link to the identified resources. The search results are typically ordered for viewing according to the rank.

The search system may also rank resources based on the performance of the resource with respect to the particular query. For example, some conventional search systems rank resources having a high click-through rate for the particular query higher than resources having a lower click-through rate for the particular query. The general assumption under such an approach is that queries are often an incomplete expression of the information needed, and the user's actions of selecting a particular resource is a signal that the resource is at least as responsive to, or more responsive to, the user's informational need than the other identified resources.

### SUMMARY

In general, some innovative aspects of the subject matter described in this specification can be embodied in methods that include the actions of obtaining, for each of a plurality of images, a selection vector for the image, the selection vector including a plurality of vector elements, each vector element corresponding to a unique search query, and the value of each vector element being proportional to a number of selections of image search results that included a representation of the image when the search results were presented in response to the unique search query; identifying a category for each search query of each selection vector, each category for a search query belonging to a set of categories; for each image: determining a first number of selections of image search results that included a representation of the image for search queries categorized as belonging to a proper subset of the set of categories; determining a total number of selections of image search results that included a representation of the image; and determining that the image is a click magnet image based at least in part on the first number of selections and the total number of selections. Other embodiments of this aspect include corresponding systems, apparatus, and computer programs, configured to perform the actions of the methods, encoded on computer storage devices.

These and other implementations can each optionally include one or more of the following features. Determining that the image is a click magnet image based at least in part on the first number of selections and the total number of selections can include: determining a ratio of the first number of selections to the total number of selections; determining that the ratio satisfies a threshold; and in response to determining that the ratio satisfies the threshold, determining that the image is a click magnet image.

Determining that the image is a click magnet image based at least in part on the first number of selections and the total number of selections further can include: identifying each web site that publishes the image; determining, for each identified web site, whether the identified web site is a click magnet web site based on a number of click magnet images published by the web site and a total number of images published by the web site; determining that none of the identified web sites is a click magnet web site; and in response to determining that none of the identified web sites is a click magnet web site, determining that the image is not a click magnet image.

Aspects can further include, for each of a set of websites: determining a number of click magnet images published by the web site; determining a total number of images published by the web site; and classifying the web site as a click magnet web site or a non-click magnet web site based on the number of click magnet images published by the web site and the total number of images published by the web site.

Classifying the web site as a click magnet web site or a non-click magnet web site based on the number of click magnet images published by the web site and the total number of images published by the web site can include: determining a ratio of the number of click magnet images published by the web site to the total number of images published by the web site; determining that the ratio exceeds a threshold; and in response to determining that the ratio exceeds the threshold, classifying the web site as a click magnet site. Aspects can further include determining that each image published by each web site classified as a click magnet site is a click magnet image.

Classifying the web site as a click magnet web site or a non-click magnet web site based on the number of click magnet images published by the web site and the total number of images published by the web site can include: determining a ratio of the number of click magnet images published by the web site to the total number of images published by the web site; determining that the ratio is less than a threshold; and in response to the ratio being less than the threshold, classifying the web site as a non-click magnet site.

Aspects can further include ranking the plurality of images based on the first number of selections for each image; and determining that a number of the highest ranking images are click magnet images.

The set of categories can include at least one of a funny category, a gory category, and a violence category. Identifying a category for each search query of the selection vector can include providing the search query to a classifier.

Aspects can further include modifying a ranking of an image determined to be a click magnet image to increase the image's ranking relative to other images for search queries having a category belonging to the set of categories.

Aspects can further include modifying a ranking of an image determined to be a click magnet image to decrease the image's ranking relative to other images for search queries having a category that does not belong to the set of categories.

A click magnet image can be an image that receives a large number of selections for reasons other than quality and relevance to received search queries. Each category of the proper subset of categories can be a category identified as being a click magnet seeking category.

Determining that the image is a click magnet image based at least in part on the first number of selections and the total number of selections can include: determining a ratio of the first number of selections to a second number of selections, the second number of selections being selections of image search results that included a representation of the image for search queries categorized as belonging to a second subset of categories, each category of the second subset of categories being different than each category of the proper subset of categories; determining that the ratio satisfies a threshold; and in response to determining that the ratio satisfies the threshold, determining that the image is a click magnet image.

While click-through rates can be a strong ranking signal for resources, some resources receive a large number of selections for reasons other than quality or relevance to a particular query. For example, users searching for general images of sharks may submit the query “sharks.” If an image—or representative thereof—of a violent shark attack is provided as a search result responsive to the query “sharks,” this image may receive a large number of selections although the image may not be as relevant to the query as other provided images. These images can skew image search result rankings that use click-through rates as a ranking signal.

Particular embodiments of the subject matter described in this specification can be implemented so as to realize one or more of the following advantages or features. Images that receive a large number of selections for reasons other than quality and relevance (“click magnet images”) when provided as a search result can be identified. Image search results responsive to a search query can be more accurately ordered by accounting for click magnet images. Web sites that publish click magnet images can be identified and used to identify click magnet images. Similarly, non-click magnet web sites that publish few, if any, click magnet images can be identified and used to determine that images published by the web site are not click magnet images. Search queries can be classified as click-magnet seeking or non-click magnet seeking, for example based on a category of the search query.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a search system provides search services.

FIG. 2 is an illustration of an example table that maps images to search queries.

FIG. 3 is a flow chart of an example process for identifying click magnet images.

FIG. 4 is a flow chart of another example process for identifying click magnet images.

FIG. 5 is a flow chart of another example process for identifying click magnet images.

FIG. 6 is a flow chart of an example process for ordering image search results and providing the image search results in response to a search query.

Like reference numbers and designations in the various drawings indicate like elements.

### DETAILED DESCRIPTION

In general, the subject matter of this specification relates to identifying click magnet images and accounting for click magnet images in image search result ranking Click magnet images can be defined as images that receive a large number of selections for reasons other than quality and relevance when provided as search results. One example of a click magnet image is an image depicting a funny caricature of a well-known person. For general search queries directed to the person, the caricature image may not be as relevant as other images, but may receive a larger number of selections because of the nature of the caricature image.

Click magnet images typically fall within one of several image categories, such as violent, sexual, gory, morbid, funny, or extreme. Click magnet images can be identified based, at least in part on, categories of search queries that led to the selection of search results having a representation of the image. In some implementations, search queries may be categorized based on the type of content that the search queries are directed to. For example, the search query “deadly shark attacks” may be categorized as extreme, violent, and/or gory. Search queries categorized in one or more click magnet categories may be deemed a click magnet seeking query. Search queries that are not categorized in a click magnet category may be deemed a non-click magnet seeking query. An image that receives a large number of selections when presented in search results for click magnet seeking queries relative to the number of selections when presented in search results for non-click magnet seeking queries—or relative to a total number of selections for the image—may be deemed a click magnet image.

Web sites can be classified as click magnet sites or non-click magnet sites, for example based on the number of click magnet images published by the web site relative to the total number of images published by the web site. If a web site publishes a large fraction of click magnet images, then the web site may be deemed a click magnet site. Each image published by a click magnet site may be deemed a click magnet image, for example regardless of an initial classification of the image as a non-click magnet image. Similarly, if a web site has a small fraction of click magnet images, then the web site may be deemed a non-click magnet site. Images that are published by non-click magnet sites only may be deemed non-click magnet images, for example regardless of an initial classification of the images as click magnet images.

The click magnet designation can be used to rank or to determine a rank score for the images for search queries. For example, a click magnet image may be demoted for non-click magnet seeking queries and promoted for click magnet seeking queries.

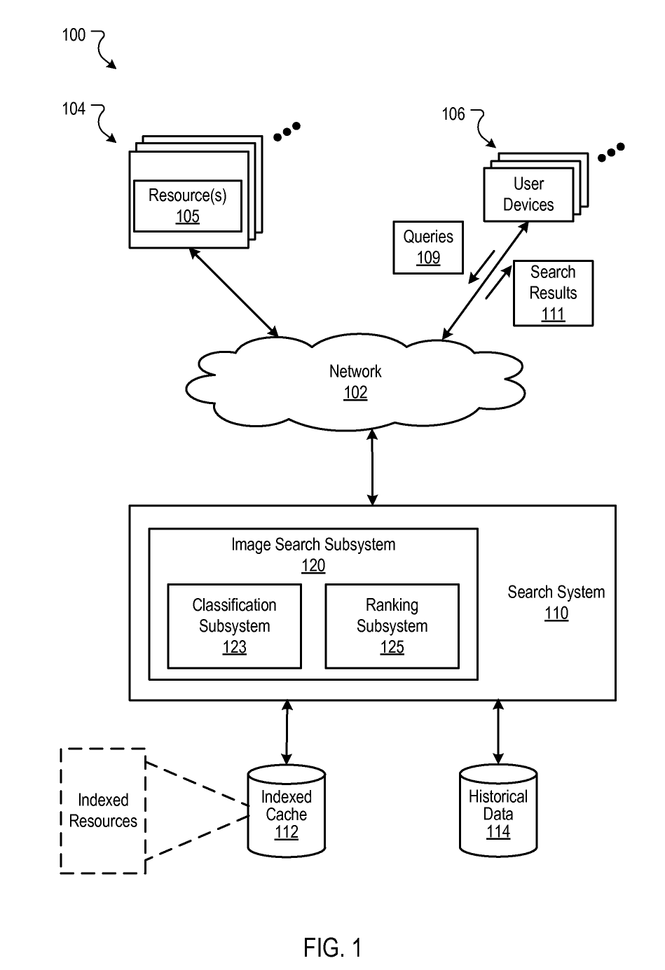

FIG. 1 is a block diagram of an example environment 100 in which a search system 110 provides search services. A computer network 102, such as a local area network (LAN), wide area network (WAN), the Internet, a mobile phone network, or a combination thereof, connects web sites 104, user devices 106, and the search system 110. The environment 100 may include multiple web sites 104 and user devices 106.

A web site 104 is one or more resources 105 associated with a domain name and hosted by one or more servers. An example web site 104 is a collection of web pages formatted in hypertext markup language (HTML) that can contain text, images, multimedia content, and programming elements, such as scripts. Each web site 104 is maintained by a publisher, e.g., an entity that manages and/or owns the web site.

A resource 105 is any data that can be provided by a web site 104 over the network 102 and that is associated with a resource address. Resources 105 include HTML pages, word processing documents, portable format (PDF) documents, images, video, and feed sources, to name just a few. The resources 105 can include content, such as words, phrases, images, and sound, and may include embedded information, e.g., meta information and hyperlinks, and/or embedded instructions, e.g., scripts.

A user device 106 is an electronic device that is under control of a user and is capable of requesting and receiving resources 105 over the network 102. Example user devices 106 include personal computers, mobile communication devices, and other devices that can send and receive data over the network 102. A user device 106 typically includes a user application, such as a web browser, to facilitate the sending and receiving of data over the network 102.

To facilitate searching of resources 105, the search system 110 identifies the resources 105 by crawling and indexing the resources 105 provided on web sites 104. Data about the resources 105 can be indexed based on the resource 105 to which the data corresponds. The indexed and, optionally, cached copies of the resources 105 are stored in an indexed cache 112.

A user device, such as user device 106, can submit a search query 109 to the search system 110. The search system 110 performs a search operation that uses the search query 109 as input to identify resources 105 responsive to the search query 109. For example, the search system 110 may access the indexed cache 112 to identify resources 105 that are relevant to the search query 109. The search system 110 identifies the resources 105, generates search results 111 that identify the resources 105, and returns the search results 111 to the user devices 106.

The search query 109 can include one or more search terms. A search term can, for example, include a keyword submitted as part of a search query 109 to the search system 110 that is used to retrieve responsive search results 111.

A search result 111 is data generated by the search system 110 that identifies a resource 105 that is responsive to a particular search query 109, and includes a link to the resource 105. An example search result 111 can include a web page title, a snippet of text or an image or portion thereof extracted from the web page, and a hypertext link, e.g., a uniform resource locator (URL), to the web page. An image search result typically includes a representation of the image referenced by the search result, but is often not the referenced image. For example an image search result may include a reduced-sized version of the referenced image, e.g., a thumbnail image, or a cropped version of the referenced image.

The search terms in the search query 109 control the search results 111 that are identified by the search system 110. Although the actual ranking of the search results 111 varies based on the ranking algorithm used by the search system 110, the search system 110 can retrieve and rank search results 111 based on the search terms submitted through a search query 109.

For a search directed to text, the search results 111 are typically ranked based on scores related to resources 105 identified by the search results 111, such as information retrieval (“IR”) scores, and optionally a score of each resource relative to other resources. The search results 111 are ordered according to these relevance scores and are provided to the user device 106 according to the order.

The user devices 106 receive the search results pages and render the pages for presentation to the users. In response to the user selecting a search result 111 at a user device 106, the user device 106 requests the resource identified by the resource locator included in the search result 111. The web site 104 hosting the resource 105 receives the request for the resource 105 from the user device 106 and provides the resource 105 to the requesting user device 106.

Data for the search queries 109 submitted during user sessions are stored in a data store, such as the historical data store 114. For example, for search queries that 109 are in the form of text, the text of the query is stored in the historical data store 114. For search queries 109 that are in the form of images, an index of the images is stored in the historical data store 114, or, optionally, the image is stored in the historical data store 114.

Selection data specifying actions taken in response to search results 111 provided in response to each search query 109 are also stored in the historical data store 114. These actions can include whether a search result 111 was selected, and for each selection, for which search query 109 the search result 111 was provided. The data stored in the historical data store 114 can be used to map search queries 109 submitted during search sessions to resources 105 that were identified in search results 111 and the actions taken. For example, the historical data can map how many times each image indexed in the indexed cache 112 was selected when presented in the form of a search result 111. As used herein, an image that is referenced in a search result is considered to be selected when the search result referencing the image is selected.

The search system 110 includes an image search subsystem 120 to provide images as search results 111 in response to search queries 109. The image search subsystem 120 includes a classification subsystem 123 that identifies click magnet images and an image ranking subsystem 125 that ranks image search results. Although described as subsystems, the image search subsystem 120, the classification subsystem 123, and the image ranking subsystem 125 can each be implemented as an entirely separate system in data communication with the search system 110.

The classification subsystem 123 identifies click magnet images indexed in the indexed cache 112 and designates the identified click magnet images accordingly in the indexed cache 112. For example, the classification subsystem 123 may analyze data stored in the historical data logs 114 for each indexed image to determine whether the image is a click magnet image. If an indexed image is determined to be a click magnet image, the classification subsystem 123 may indicate that the image is a click magnet image in the indexed cache 112.

The classification subsystem 123 can determine whether an image is a click magnet image based on the search queries 109 for which the image was provided as a search result 111 and selected by users. In some implementations, the classification subsystem 123 determines whether an image is a click magnet image based on the number of times the image was selected for certain categories of search queries 109 relative to the total number of times the image was selected for all search queries 109 for which the image was referenced by a search result.

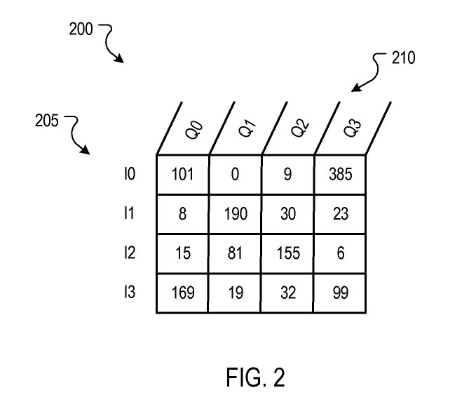

As described below, the classification subsystem 123 can process the query and selection data stored in the historical data store 114 to form a table or matrix in which each row corresponds to a unique image, and each column corresponds to a unique search query. The intersection of each row and column corresponds to a value that is proportional to the number of times the image of the row was selected in response to the search query corresponding to the column. In some implementations, the value of each element in a row is the number of selections, e.g., click and/or hover, that a corresponding image has received for a search query corresponding to the column intersecting the row. An example table is illustrated in FIG. 2 and described below.

In some implementations, the classification subsystem 123 generates a selection vector for each image. Each selection vector element corresponds to a unique search query, and the value of each vector element is proportional to the number of selections the image received in response to the image being presented in a search result for the unique search query corresponding to the vector element. The selection vectors can correspond to rows in a matrix or table, where each row corresponds to a unique image and each column corresponds to a unique search query 109.

The classification subsystem 123 can identify click magnet seeking queries in the selection vectors or table. For example, the classification subsystem 123 can analyze each search query 109 of the selection vectors to determine whether the search query 109 is a click magnet seeking query and label the click magnet seeking queries accordingly. In some implementations, the classification subsystem 123 stores information identifying the click magnet seeking queries and non-click magnet seeking queries in the historical data store 114. For example, the classification subsystem 123 may set a parameter for each search query 109 stored in the historical data store 114 that indicates whether the search query 109 is a click magnet seeking query or a non-click magnet seeking query.

In some implementations, the classification subsystem 123 determines whether a search query 109 is a click magnet seeking query based on the type of content for which the search query 109 is directed. For example, click magnet images typically fall within one of several image categories, such as violent, sexual, gory, morbid, funny, or extreme. If an image receives a large number of selections for search queries directed to such categories of images, then the image may be deemed a click magnet image.

The classification subsystem 123 can identify one or more categories for each search query 109, e.g., based on the terms of the search query 109 and/or based on search results related to the search query 109. For example, the classification subsystem 123 can identify each search query 109 as belonging to one or more of a set of search query categories. The classification subsystem 123 can also compare the one or more categories for a search query 109 to a proper subset of search query categories identified as being click magnet seeking query categories. If there is a match between the one or more categories for a search query 109 and a click magnet seeking query category of the proper subset, then the classification subsystem 123 may identify or classify the search query 109 as a click magnet seeking query. If there is not a match between the one or more categories for a search query 109 and a click magnet seeking query category of the proper subset, then the classification subsystem 123 may identify or classify the search query 109 as a non-click magnet seeking query. For example, the one or more categories for the search query 109 may belong to a second subset of categories of the set of categories identified as being non-click magnet seeking query categories. The prober subset of click magnet categories may be specified by a system designer, for example.

In some implementations, the classification subsystem 123 determines whether a search query is a click magnet seeking query using one or more machine learning classifiers. For example, the classification subsystem 123 may provide a search query 109 as input to a binary classifier that outputs a value indicating whether the search query 109 is a click magnet seeking query. The binary classifier may be based on a list of n-grams such that, if the search query contains one of the n-grams, the search query 109 is considered a click magnet seeking query. In some implementations, the classification subsystem 123 determines the list of n-grams using Latent Semantic Indexing (LSI). Other Natural Language Processing (NLP) and/or machine learning technologies can be used to identify query features and generate a query classifier for use in identifying click magnet seeking queries.

The classification subsystem 123 can use the selection vectors or table and the classifications for each search query 109, e.g., whether the search query is classified as a click magnet seeking query or a non-click magnet seeking query, to determine the number of selections that each image received when presented in response to click magnet seeking queries. The classification subsystem 123 can use the number of selections an image received when presented in response to click magnet seeking queries to determine whether the image is a click magnet image. In some implementations, the classification subsystem 123 computes the ratio of the number of selections an image received when presented in response to click magnet seeking queries to the total number of selections the image received for all search queries 109 for which the image was referenced by a search result. If this ratio satisfies a threshold, the classification subsystem 123 may classify the image as a click magnet image. For example, the ratio may satisfy the threshold by meeting or exceeding the threshold. If the ratio does not satisfy the threshold, the classification system 123 may classify the image as a non-click magnet image or not classify the image. This threshold may be specified by a system designer, for example.

The classification subsystem 123 can also classify web sites as click magnet sites or non-click magnet sites. In some implementations, the classification subsystem 123 determines whether a web site is a click magnet site based, at least in part, on the number of click magnet images published by the web site. For example, the classification system 123 may determine whether a web site is a click magnet site based on a ratio of the number of click magnet images published by the web site to the total number of images published by the web site.

In some implementations, the classification subsystem 123 compares the ratio to a threshold and if the ratio satisfies the threshold, the classification subsystem 123 may classify the web site as a click magnet site. For example, the ratio may satisfy the threshold by meeting or exceeding the threshold. If the ratio does not satisfy the threshold, the classification subsystem 123 may classify the web site as a non-click magnet site. This threshold may be specified by a system designer, for example.

In some implementations, the classification subsystem 123 compares the ratio to two thresholds, an upper threshold and a lower threshold, to determine how to classify the web site. If the ratio exceeds the upper threshold, the classification subsystem 123 may classify the web site as a click magnet site. If the ratio does not exceed the lower threshold, the classification subsystem 123 may classify the web site as a non-click magnet site. If the ratio is between the upper threshold and the lower threshold, the classification subsystem 123 may not classify the web site. These thresholds may be specified by a system designer, for example.

The classification subsystem 123 can use the classification of web sites to identify click magnet images or to reclassify images previously classified as a click magnet image or a non-click magnet image. For example, the classification subsystem 123 may determine that all images published by a click magnet site are click magnet images. If an image was previously determined to not be a click magnet image, for example based on the number of selections the image received for click magnet seeking queries, then the classification subsystem 123 may reclassify the image as a click magnet image based on one or more click magnet web sites publishing the image. Similarly, if an image is determined to be a click magnet image, but is published by non-click magnet sites only, then the classification subsystem 123 may determine that the image is not a click magnet image and reclassify accordingly.

In some implementations, the classification subsystem 123 considers the size of the web site, e.g., number of images published by the web site, to determine whether to reclassify images published by the web site. For example, the classification subsystem 123 may allow reclassification of images published by web sites having a size that satisfies a size threshold only. The size of a particular web site may satisfy the threshold by meeting or exceeding the threshold.

The classification subsystem 123 can generate a list of click magnet images. The list of click magnet images can include the images determined to be click magnet images based on the number of selections for click magnet seeking queries and the images determined to be click magnet images based on the classification of the web sites that publish the images.

The classification subsystem 123 can also generate a table or matrix that maps search queries to images. For example, the classification subsystem 123 may invert the table described above that maps images to search queries to generate the table the maps search queries to images. Using this table and the list of click magnet images, the classification subsystem 123 can determine, for each search query, the number of unique click magnet images that have been selected when provided as a search result responsive to the search query. If the number of unique click magnet images for a search query satisfies a threshold, then the classification subsystem 123 may determine that the search query is a click magnet seeking query. For example, the number of unique click magnet images for a search query may satisfy the threshold by meeting or exceeding the threshold.

For each click magnet seeking query, the classification subsystem 123 can rank the images that have been selected when provided in response to the click magnet seeking query based on the number of times the images have been selected when provided in response to the click magnet seeking query. The classification subsystem 123 can classify the highest ranked images, e.g., the top 20 images, for each click magnet seeking query as a click magnet image.

The image search subsystem 120 ranks image search results, for example based on a relevance measure of images to a search query 109. For a search directed to images that uses a text query as input, the image search subsystem 120 can combine the relevance score of a resource 105 with a relevance feedback score of an image embedded in the resource 105 to derive a rank score for the image. An example relevance feedback score is a score derived from a selection rate, e.g., click-through rate, of an image when that image is referenced in a search result 111 for a search query 109. The ranks score are then used to present search results 111 directed to the images embedded in the resources 105.

The relevance scores for an image can be based on labels that are associated with the image. Labels are text or data flags that indicate a topic to which the image belongs. Labels can be explicitly associated with an image, for example, by the publisher that is providing the image. For example, a publisher can associate the text “football” with an image that includes content that is directed to football, e.g., an image of a football or a football player. Labels can also be explicitly associated with an image by users to whom the image is presented.

Labels can also be associated with an image based on the relevance feedback for the image. For example, a label matching a search query 109 can be associated with an image when the image is selected for presentation by the users at a rate that satisfies a threshold selection rate. For example, the rate of selection by the users may satisfy the threshold selection rate by meeting or exceeding the threshold selection rate. The threshold selection rate can be specified as a portion of the total search results 111 for the search query 109 in which the image is referenced. In turn, the label can then be used to select the image for reference in search results 111 responsive to future instances of the search query 109.

The relevance score for an image can be based on how well an image label matches the search query 109. For example, an image having a label that is the same as the search query 109 can have a higher relevance score to the search query 109 than an image having a label that is a root of the search query 109 or otherwise matches the search query 109 based on query expansion techniques, e.g., synonym identification or clustering techniques. Similarly, images having labels that match the search query 109 are identified as more relevant to the search query 109 than images that do not have labels matching the search query 109. In turn, images having labels that match the search query 109 may be selected for reference at higher search positions than images that do not have labels that match the search query 109.

The rank score for an image can also take into account whether the image is classified as a click magnet image and whether the search query 109 is classified as a click magnet seeking query. For example, the rank score for a click magnet image may be adjusted to promote the click magnet image for a click magnet seeking search query, or to demote the click magnet image for a non-click magnet seeking search query. Similarly, the rank score for a non-click magnet image may be adjusted to promote the non-click magnet image for a non-click magnet seeking search query, or to demote the non-click magnet image for a click magnet seeking search query.

FIG. 2 is an illustration of an example table 200 that maps images to search queries. The table 200 includes several rows 205 that each correspond to a unique image and several columns 210 that each correspond to a unique search query 109. The intersection of each row and column includes a value that is proportional to the number of times the image of the row was selected in response to the search query corresponding to the column. For the query Q0, the table 200 indicates that the image I0 has been selected 101 times, the image I1 has been selected 8 times, the image I2 has been selected 15 times, the image I3 has been selected 169 times; and so on for the queries Q1, Q2, and Q3.

In some implementations, the classification subsystem 123 computes, for each image I0-I3, the ratio of the number of selections the image has received for click magnet seeking queries to the number of selections for non-click magnet seeking queries. By way of example, consider queries Q0 and Q3 to be click magnet seeking queries and queries Q1 and Q2 to be non-click magnet seeking queries. For image I0, this ratio would be (101+385)/(0+9)=54. If the threshold ratio for determining whether an image is a click magnet image is less than 54, then the classification subsystem 123 may classify image I0 as a click magnet image.

In some implementations, the classification subsystem 123 computes, for each image I0-I3, the ratio of the number of selection the image has received for click magnet seeking queries to the total number of times the image has been selected. By way of example, consider again that queries Q0 and Q3 are click magnet seeking queries and queries Q1 and Q2 are non-click magnet seeking queries. For image I0, this ratio would be (101+385)/(101+385+9)=0.982. If the threshold ratio for determining whether an image is a click magnet image is less than 0.982, then the classification subsystem 123 may classify image I0 as a click magnet image.

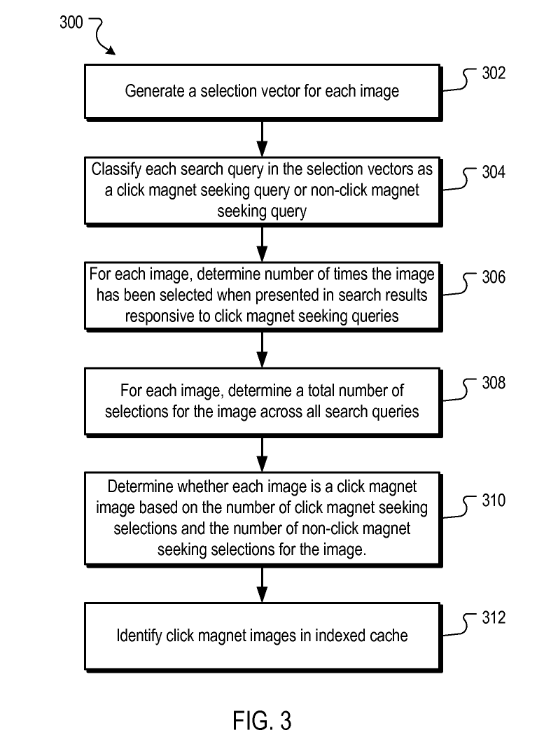

FIG. 3 is a flow chart of an example process 300 for identifying click magnet images. The process 300 can, for example, be implemented by a data processing apparatus of the classification subsystem 123 of FIG. 1.

The process 300 generates, for each of a multitude of images, a selection vector for the image (302). For example, the classification subsystem 123 may generate a selection vector for each image indexed in the indexed cache 112 using data stored in the historical data store 114. The selection vectors can correspond to rows in a matrix or table, where each row corresponds to a unique image and each column corresponds to a unique search query 109. The value of each vector element is proportional to a number of selections the image has received in response to the image being presented in a search result for the unique search query corresponding to the vector element. An example table having selection vectors for several images is illustrated in FIG. 2 and described above.

The process 300 classifies each search query 109 of the selection vectors as a click magnet seeking query or a non-click magnet seeking query (304). For example, the classification subsystem 123 may classify each search query 109 as a click magnet seeking query or a non-click magnet seeking query based on a category for the search query 109 or using a machine learning classifier.

In some implementations, the classification subsystem 123 determines one or more categories for each search query 109, e.g., based on the terms of the search query 109, and compares the one or more categories to a set of click magnet categories. For example, the click magnet categories may include violent, sexual, gory, morbid, funny, and/or extreme, to name a few. If there is a match between the one or more categories for a search query 109 and a click magnet category, then the classification subsystem 123 may identify the search query 109 as a click magnet seeking query.

In some implementations, the classification subsystem 123 determines whether a search query is a click magnet seeking query using one or more machine learning classifiers. For example, the classification subsystem 123 may provide a search query 109 as input to a binary classifier that outputs a value indicating whether the search query 109 is a click magnet seeking query.

The process 300 determines, for each of the multitude of images, a number of times the image has been selected when presented as a search result in response to click magnet seeking queries (306). For example, the classification subsystem 123 can use the selection vector for the image and the classification of the search queries in the selection vector to determine the number of times the image has been selected when presented as a search result in response to click magnet seeking queries. For instance, the classification subsystem 123 can determine the sum of the selections for each search query in the selection vector classified as a click magnet seeking query.

The process 300 determines, for each of the multitude of images, a total number of times the image has been selected when presented as a search result for all search queries (308). For example, the classification subsystem 123 can determine the total number of selections for the image by computing the sum of all selections included in the selection vector for the image.

The process 300 determines, for each of the multitude of images, whether the image is a click magnet image based on the number of times the image has been selected when presented as a search result in response to click magnet seeking queries and the total number of times the image has been selected (310). In some implementations, the classification subsystem 123 determines the ratio of the number of times the image has been selected when presented as a search result in response to click magnet seeking queries to the total number of times the image has been selected. The classification subsystem 123 compares this ratio to a threshold and, if the ratio satisfies the threshold, determines that the image is a click magnet image. For example, the ratio may satisfy the threshold by meeting or exceeding the threshold. If the ratio does not satisfy the threshold, the classification subsystem 123 determines that the image is not a click magnet image.

The process 300 identifies the click magnet images in the indexed cache 112. For example, the classification subsystem 123 may label or otherwise designate each image determined to be a click magnet image in the indexed cache 112. By labeling the click magnet images in the indexed cache 112, the ranking subsystem 125 can reference the indexed cache 112 to identify click magnet images during image ranking processes.

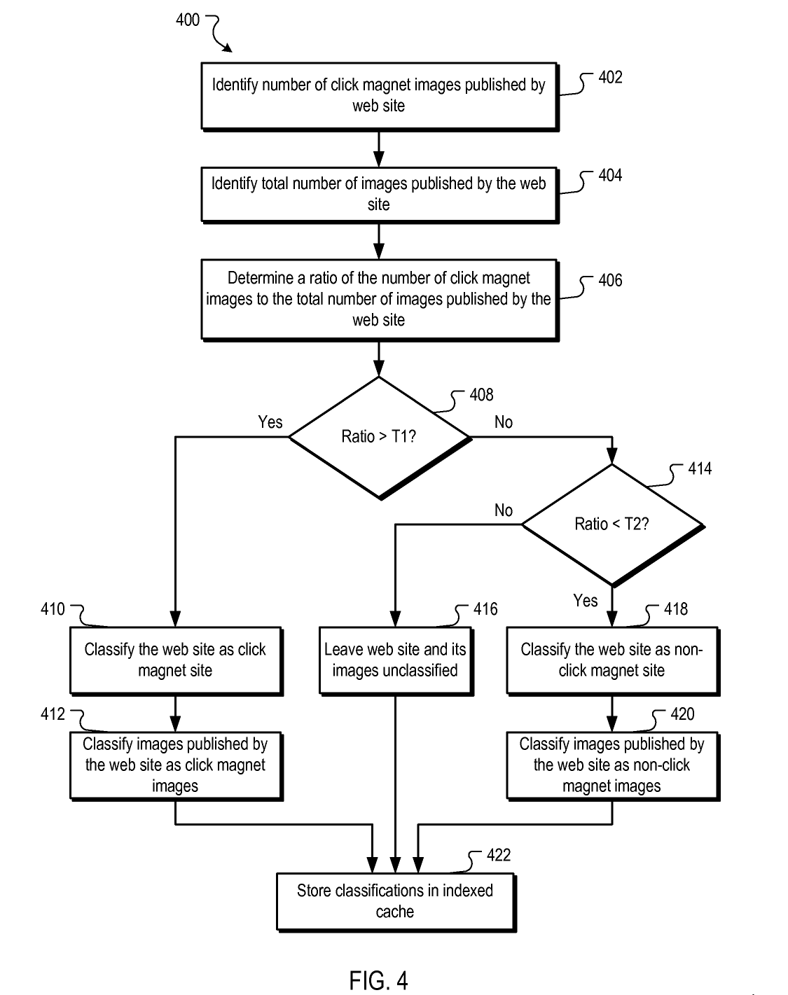

FIG. 4 is a flow chart of another example process 400 for identifying click magnet images. The process 400 can, for example, be implemented by a data processing apparatus of the classification subsystem 123 of FIG. 1. In some implementations the classification subsystem 123 performs the process 400 for a multitude of web sites to identify additional click magnet images that may not have been identified by the process 300 of FIG. 3. The process 400 also may be used to confirm the image classifications made in the process 300 of FIG. 3.

The process 400 identifies a number of click magnet images published by a web site (402). For example, the classification subsystem 123 can select a web site that publishes images and identify each image published by the web site. The classification subsystem 123 can also determine, for each identified image, whether the image is a click magnet image, for example using the information stored in the indexed cache 112.

In some implementations, a multitude of images are indexed in the indexed cache 112 and those images determined to be click magnet images are labeled as click magnet images in the indexed cache 112. The classification subsystem 112 can determine whether each image published by the web site and indexed in the indexed cache 112 is a click magnet image and determine the total number of click magnet images published by the web site.

The process 400 identifies a total number of images published by the web site (404). For example, the classification subsystem 123 can determine the total number of images published by the web site.

The process 400 determines a ratio of the number of click magnet images published by the web site to the total number of images published by the web site (406). For example, the classification subsystem 123 may compute the ratio of the number of click magnet images published by the web site to the total number of images published by the web site.

The process 400 determines whether the ratio exceeds a first threshold T1 (408). For example, the classification subsystem 123 may compare the ratio to the first threshold T1, which may be set by a system designer.

If the ratio exceeds the first threshold T1, the process 400 classifies the web site as a click magnet web site (410). The process 400 also classifies images published by the web site as click magnet images (412). For example, the classification subsystem 123 may classify the web site as a click magnet site and further classify each image published by the web site as a click magnet image in response to the web site's classification.

If the ratio does not exceed the first threshold T1, the process 400 determines whether the ratio is less than a second threshold T2 (414). For example, the classification subsystem 123 may compare the ratio to the second threshold T2, which may be set by a system designer. The second threshold T2 is typically less than the first threshold T1 and is used to determine whether the web site is a non-click magnet site. For example, web sites that publish a small number of click magnet images compared to the total number of images published by the web site may be considered a non-click magnet site.

If the ratio is less than the second threshold T2, the process 400 classifies the web site as a non-click magnet site (418). In some implementations, the process 400 also classifies images published by the web site as non-click magnet images based on the web site's classification (420). For example, the classification subsystem 123 may classify the web site as a non-click magnet site and further classify each image published by the web site as a non-click magnet image in response to the web site's classification. In some implementations, the process 400 classifies images as non-click magnet images if all web sites that publish the image are classified as non-click magnet sites only.

If the ratio is not less than the second threshold T2, the process 400 leaves the web site unclassified (416). For example, the classification subsystem 123 may not classify web sites that have a ratio that is between the two thresholds T1 and T2, inclusive. The classification of the images of the web site may also remain unchanged. For example, any click magnet images published by the web site may remain classified as click magnet images and any non-click magnet images published by the web site may remain classified as non-click magnet images.

The process 400 stores the classifications of the web sites and the images in the indexed cache 112 (422). For example, the classification subsystem 123 may update the classification for images that were determined to be a different classification based on the number of selections of the images for click magnet seeking queries. If an image was not previously indexed in the indexed cache 112, the classification subsystem 123 may add that image to the indexed cache 112 with a designation specifying whether the image is a click magnet image. Similarly, the classification subsystem 123 may add the web site to the indexed cache 112, if not already indexed, with a designation specifying whether the web site is a click magnet site.

In some implementations, the size of the web site may also be used to determine whether to classify a web site as a click magnet site or a non-click magnet site. For example, the classification subsystem 123 may compare the total number of images published by the web site to a third threshold T3 to determine whether the web site can be classified. If the total number of images published by the web site does not satisfy the third threshold T3, e.g., does not exceed the third threshold T3, the classification subsystem 123 may not classify the web site as either a click magnet site or as a non-click magnet site, regardless of the web site's ratio of click magnet images to the total number of images published by the web site. The classification of the images published by the non-classified web site may also remain unchanged. If the total number of images published by the web site satisfies the third threshold T3, e.g., by exceeding the third threshold T3, the classification subsystem 123 may classify, or not classify, the web site according to the web site's ratio and the thresholds T1 and T2, as illustrated in FIG. 4 and described above.

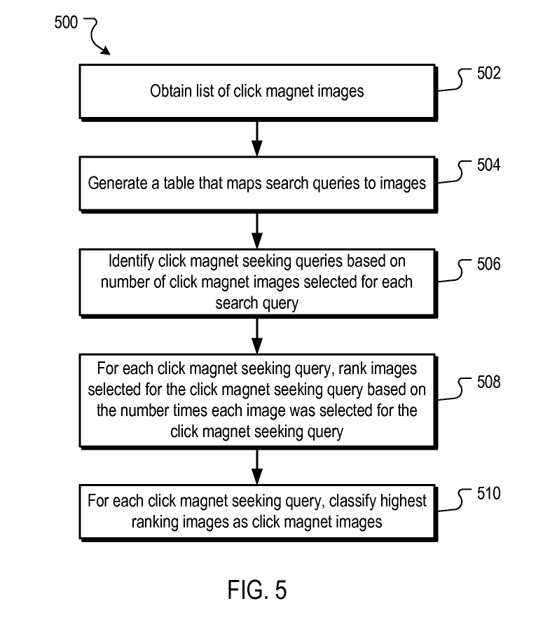

FIG. 5 is a flow chart of another example process 500 for identifying click magnet images. The process 500 can, for example, be implemented by a data processing apparatus of the classification subsystem 123 of FIG. 1. Similar to the process 400 of FIG. 4, this process 500 may be used to identify additional click magnet images and/or to confirm previous classifications of images.

The process 500 obtains a list of click magnet images (502). For example, the classification subsystem 123 may access the indexed cache 112 to identify each click magnet image referenced in the indexed cache 112. This list of click magnet images may include the click magnet images identified by the processes 300 & 400 illustrated in FIGS. 3 & 4, and described above.

The process 500 generates a table or matrix that maps search queries to images (504). This table may include click magnet images and non-click magnet images referenced in the indexed cache 112. For example, the table may include all or substantially all images referenced in the indexed cache 112 that have been selected when presented as a search result for at least one of the search queries in the table. In some implementations, this table is substantially the same as, or an inverted version of, the table or selection vectors created in the process 300 illustrated in FIG. 3 and described above.

In some implementations, the classification subsystem 123 generates an inverted search query list for each of the unique search queries using the table or selection vectors created in the process 300. For each unique search query, the inverted search query list has one or more tuples, and each tuple identifies an image and includes a non-zero vector element corresponding to the unique search query and the image. For example, for the table 200 illustrated in FIG. 2, the classification subsystem generates the following inverted search query lists:

Q0: {I0, 101}, {I1, 8}, {I2, 15}, {I3, 169}

Q1: {I0, 0}, {I1, 190}, {I2, 81}, {I3, 19}

Q2: {I0, 9}, {I1, 30}, {I2, 155}, {I3, 32}

Q3: {I0, 385}, {I1, 23}, {I2, 6}, {I3, 99}

The process 500 identifies click magnet seeking queries based on the number of click magnet images selected for each search query using the table that maps search queries to images or the inverted search query lists (506). For example, the classification subsystem 123 can identify click magnet seeking queries using the inverted search query lists and the list of click magnet images. For example, using the data in the inverted search query lists shown above, consider that the list of click magnet images indicates that images I0 and I3 are click magnet images and that I1 and I2 are not click magnet images. Based on this data, the classification subsystem 123 would find that query Q0 resulted in two click magnet images being selected (I0 and I3); query Q1 resulted in one click magnet image being selected (I3); query Q2 resulted in two click magnet images being selected (I0 and I3), and query Q3 resulted in two click magnet images being selected (I0 and I3). If the threshold number of images for being deemed a click magnet seeking query is set to two, then the classification subsystem 123 would classify queries Q0, Q2, and Q3 as click magnet seeking queries and would classify query Q1 as a non-click magnet seeking query, for example.

In some implementations, the classification subsystem 123 considers a ratio of the number of selections of click magnet images to the total number of selections of any image for the query to determine whether the query is a click magnet seeking query. For example, if this ratio satisfies a threshold, the query may be identified as a click magnet seeking query. The ratio may satisfy the threshold by meeting or exceeding the threshold. Continuing the previous example with images I0 and I3 being click magnet images, the ratio of selections of click magnet images for query Q0 to the total number of selections of images for the query Q0 would be (101+169)/(101+8+15+169)=0.922. If the threshold is less than 0.922, then the query Q0 would be identified as a click magnet seeking query.

The process 500 ranks, for each identified click magnet seeking query in the table, the images selected when presented as a search result for the click magnet seeking query based on the number of times each image was selected when presented as a search result for the click magnet seeking query (508). Continuing the above example where query Q0 is classified as a click magnet seeking query, the images for query Q0 would be ranked in the order of I3, I0, I2, I1 as image I3 has 169 selections for query Q0, I0 has 101 selections for query Q0, I2 has 15 selections for query Q0, and I1 has 8 selections for query Q0. The images for query Q2 would be ranked in the order of I2, I3, I1, I0; and the images for query Q3 would be ranked in the order of I0, I3, I1, I2.

For each identified click magnet seeking query, the process 500 identifies a certain number of the highest ranked images and classifies the highest ranked images as click magnet images (510). Continuing the above example, if the top two images in this ranking are to be classified as click magnet images, then the classification subsystem 123 would classify images I0 and I3 as click magnet images based on the ranking for query Q0. Similarly, the classification subsystem 123 would classify images I2 and I3 as click magnet images based on the ranking for query Q2 and classify images I0 and I3 as click magnet images based on the ranking for query Q3. Thus, in this example, images I0, I2, and I3 would be classified as click magnet images and image I1 would not be classified as a click magnet image.

In some implementations, the process 500 is iterated multiple times to identify click magnet images. In some implementations, the processes 300, 400, and 500 are iterated multiple times to identify click magnet images.

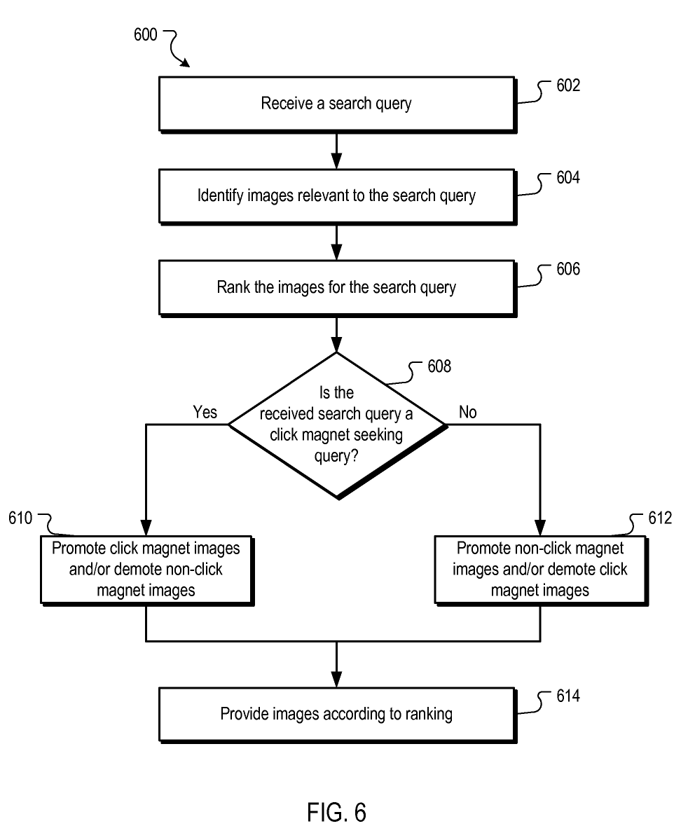

FIG. 6 is a flow chart of an example process 600 for ordering image search results and providing the image search results in response to a search query. The process 600 can, for example, be implemented by one or more data processing apparatus of the image search subsystem 120 of FIG. 1.

The process 600 receives query data defining a search query (602). The search query can be, for example, an image search query submitted by a user operating a user device 106. The query data can be received, for example, by the image search subsystem 120.

The process 600 identifies search results relevant to the received search query (604). For example, the image search subsystem 120 may obtain relevance scores for images in a corpus of images for the received search query. The relevance scores are a measure of the relevance of the images to the search query. For example, an image having a relevance score that is higher than the relevance score of another image is more relevant to the search query than the other image.

The process 600 ranks the identified images for the search query (606). In some implementations, the ranking subsystem 125 ranks the images based on the obtained relevancy scores. For example, images having a higher relevancy score for the search query may be ranked higher than images having a lower relevancy score for the search query. In some implementations, the ranking subsystem 125 ranks the images based on a rank score for each image. The rank score for an image and the search query is the combination of the relevance score with a relevance feedback score, e.g., click-through rate, for the image and search query.

The process 600 determines whether the received search query is a click magnet seeking query. In some implementations, the classification subsystem 123 compares the received search query to a list of click magnet seeking queries to determine whether the received search query is a click magnet seeking query. In some implementations, the classification subsystem 123 provides the received search query as an input to a classifier, e.g., binary classifier, that outputs a value specifying whether the input search query is a click magnet seeking query.

In some implementations, the classification subsystem 123 identifies a category for the received search query, for example based on the content for which the received search query is directed. The classification subsystem 123 compares the category of the received search query to a set of click magnet categories to determine whether the received search query is a click magnet seeking query. For example, the set of click magnet seeking categories may include violent, sexual, gory, morbid, funny, and/or extreme, to name a few. The click magnet categories may be identified by a system designer, for example.

In some implementations, the classification subsystem 123 determines whether the received search query is a click magnet seeking query based on the images identified for the received search query. For example, if the identified images include a large number of click magnet images, the classification subsystem 123 may determine that the received search query is a click magnet seeking query. In some implementations, the classification subsystem 123 determines a ratio of the number of click magnet images in the identified images to the total number of identified images. If the ratio satisfies a threshold, then the classification subsystem 123 may determine that the received search query is a click magnet seeking query. For example, the ratio may satisfy the threshold by meeting or exceeding the threshold.

If the received search query is determined to be a click magnet seeking query, the process 600 adjusts the ranking of the identified images to promote click magnet images and/or to demote non-click magnet images (610). For example, the ranking subsystem 125 may access the indexed cache 112 to determine whether each identified image in the ranking is a click magnet image and adjust the ranking of the images accordingly.

In some implementations, the ranking subsystem 125 adjusts the rank score for click magnet images and/or non-click magnet images in response to determining that the received search query is a click magnet seeking query. For example, the ranking subsystem 125 may boost rank scores for click magnet images and/or reduce rank scores for non-click magnet images in response to determining that the received search query is a click magnet seeking query.

If the received search query is determined to not be a click magnet seeking query, the process 600 adjusts the ranking of the identified images to demote click magnet images and/or to promote non-click magnet images (612). For example, the ranking subsystem 125 may access the indexed cache 112 to determine whether each identified image in the ranking is a click magnet image and adjust the ranking of the images accordingly.

In some implementations, the ranking subsystem 125 adjusts the rank score for click magnet images and/or non-click magnet images in response to determining that the received search query is not a click magnet seeking query. For example, the ranking subsystem 125 may boost rank scores for non-click magnet images and/or reduce rank scores for click magnet images in response to determining that the received search query is not a click magnet seeking query.

The process 600 provides images as search results according to the ranking (614). For example, the image search subsystem 120 may select a certain number of the highest ranked images to provide in response to the received search query. The image search subsystem 120 may generate search results that include the selected images, order the generated search results according to the image ranking, and provide the ordered search results to the user device 106 that submitted the search query.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, e.g., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media, e.g., multiple CDs, disks, or other storage devices.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program, also known as a program, software, software application, script, or code, can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network, e.g., the Internet, and peer-to-peer networks, e.g., ad hoc peer-to-peer networks.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a client device, e.g., for purposes of displaying data to and receiving user input from a user interacting with the client device. Data generated at the client device, e.g., a result of the user interaction, can be received from the client device at the server.

While this specification contains many specific implementation details, these should not be construed as limitations on the scope of this document or of what may be claimed, but rather as descriptions of features specific to particular implementations of the subject matter. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
obtaining, for each of a plurality of images, a selection vector for the image, the selection vector including a plurality of vector elements, each vector element corresponding to a unique search query, and the value of each vector element being proportional to a number of selections of image search results that included a representation of the image when the search results were presented in response to the unique search query;
identifying a category for each search query of each selection vector, each category for a search query belonging to a set of categories;
for each image:
determining a first number of selections of image search results that included a representation of the image for search queries categorized as belonging to a category that belongs to a proper subset of the set of categories;
determining a total number of selections of image search results that included a representation of the image; and
determining that the image is a click magnet image based at least in part on the first number of selections and the total number of selections.

2. The method of claim 1, wherein determining that the image is a click magnet image based at least in part on the first number of selections and the total number of selections comprises:
determining a ratio of the first number of selections to the total number of selections;
determining that the ratio satisfies a threshold; and
in response to determining that the ratio satisfies the threshold, determining that the image is a click magnet image.

3. The method of claim 2, wherein determining that the image is a click magnet image based at least in part on the first number of selections and the total number of selections further comprises:
identifying each web site that publishes the image;
determining, for each identified web site, whether the identified web site is a click magnet web site based on a number of click magnet images published by the web site and a total number of images published by the web site;
determining that none of the identified web sites is a click magnet web site; and
in response to determining that none of the identified web sites is a click magnet web site, determining that the image is not a click magnet image.

4. The method of claim 1, further comprising:
for each of a plurality of websites:
determining a number of click magnet images published by the web site;
determining a total number of images published by the web site; and
classifying the web site as a click magnet web site or a non-click magnet web site based on the number of click magnet images published by the web site and the total number of images published by the web site.

5. The method of claim 4, wherein classifying the web site as a click magnet web site or a non-click magnet web site based on the number of click magnet images published by the web site and the total number of images published by the web site comprises:
determining a ratio of the number of click magnet images published by the web site to the total number of images published by the web site;
determining that the ratio exceeds a threshold; and
in response to determining that the ratio exceeds the threshold, classifying the web site as a click magnet site.

6. The method of claim 5, further comprising determining that each image published by each web site classified as a click magnet site is a click magnet image.

7. The method of claim 4, wherein classifying the web site as a click magnet web site or a non-click magnet web site based on the number of click magnet images published by the web site and the total number of images published by the web site comprises:
determining a ratio of the number of click magnet images published by the web site to the total number of images published by the web site;
determining that the ratio is less than a threshold; and
in response to the ratio being less than the threshold, classifying the web site as a non-click magnet site.

8. The method of claim 1, further comprising:
ranking the plurality of images based on the first number of selections for each image; and
determining that a number of the highest ranking images are click magnet images.

9. The method of claim 1, wherein the set of categories includes at least one of a funny category, a gory category, and a violence category.

10. The method of claim 1, wherein identifying a category for each search query of the selection vector comprises providing the search query to a classifier.

11. The method of claim 1, further comprising modifying a ranking of an image determined to be a click magnet image to increase the image's ranking relative to other images for search queries having a category belonging to the set of categories.

12. The method of claim 1, further comprising modifying a ranking of an image determined to be a click magnet image to decrease the image's ranking relative to other images for search queries having a category that does not belong to the set of categories.

13. The method of claim 1, wherein a click magnet image is an image that receives a large number of selections for reasons other than quality and relevance to received search queries.

14. The method of claim 1, wherein each category of the proper subset of categories is a category identified as being a click magnet seeking category.

15. The method of claim 1, wherein determining that the image is a click magnet image based at least in part on the first number of selections and the total number of selections comprises:
determining a ratio of the first number of selections to a second number of selections, the second number of selections being selections of image search results that included a representation of the image for search queries categorized as belonging to a second subset of categories, each category of the second subset of categories being different than each category of the proper subset of categories;
determining that the ratio satisfies a threshold; and
in response to determining that the ratio satisfies the threshold, determining that the image is a click magnet image.

16. A system comprising:
a data store for storing selection vectors; and
one or more processors configured to interact with the data store, the one or more processors being further configured to perform operations comprising:
obtaining, for each of a plurality of images, a selection vector for the image, the selection vector including a plurality of vector elements, each vector element corresponding to a unique search query, and the value of each vector element being proportional to a number of selections of image search results that included a representation of the image when the search results were presented in response to the unique search query;
identifying a category for each search query of each selection vector, each category for a search query belonging to a set of categories;
for each image:
determining a first number of selections of image search results that included a representation of the image for search queries categorized as belonging to a proper subset of the set of categories;
determining a total number of selections of image search results that included a representation of the image; and
determining that the image is a click magnet image based at least in part on the first number of selections and the total number of selections.

17. The system of claim 16, wherein determining that the image is a click magnet image based at least in part on the first number of selections and the total number of selections comprises:
determining a ratio of the first number of selections to the total number of selections;
determining that the ratio satisfies a threshold; and
in response to determining that the ratio satisfies the threshold, determining that the image is a click magnet image.

18. The system of claim 17, wherein determining that the image is a click magnet image based at least in part on the first number of selections and the total number of selections further comprises:
identifying each web site that publishes the image;
determining, for each identified web site, whether the identified web site is a click magnet web site based on a number of click magnet images published by the web site and a total number of images published by the web site;
determining that none of the identified web sites is a click magnet web site; and
in response to determining that none of the identified web sites is a click magnet web site, determining that the image is not a click magnet image.

19. The system of claim 16, wherein the one or more processors are further configured to perform operations comprising:
for each of a plurality of websites:
determining a number of click magnet images published by the web site;
determining a total number of images published by the web site; and
classifying the web site as a click magnet web site or a non-click magnet web site based on the number of click magnet images published by the web site and the total number of images published by the web site.

20. The system of claim 19, wherein classifying the web site as a click magnet web site or a non-click magnet web site based on the number of click magnet images published by the web site and the total number of images published by the web site comprises:
determining a ratio of the number of click magnet images published by the web site to the total number of images published by the web site;
determining that the ratio exceeds a threshold; and
in response to determining that the ratio exceeds the threshold, classifying the web site as a click magnet site.

21. The system of claim 20, wherein the one or more processors are further configured to perform operations comprising determining that each image published by each web site classified as a click magnet site is a click magnet image.

22. The system of claim 19, wherein classifying the web site as a click magnet web site or a non-click magnet web site based on the number of click magnet images published by the web site and the total number of images published by the web site comprises:
determining a ratio of the number of click magnet images published by the web site to the total number of images published by the web site;
determining that the ratio is less than a threshold; and
in response to the ratio being less than the threshold, classifying the web site as a non-click magnet site.

23. The system of claim 16, wherein the one or more processors are further configured to perform operations comprising:
ranking the plurality of images based on the first number of selections for each image; and
determining that a number of the highest ranking images are click magnet images.

24. The system of claim 16, wherein the one or more processors are further configured to perform operations comprising modifying a ranking of an image determined to be a click magnet image to increase the image's ranking relative to other images for search queries having a category belonging to the set of categories.

25. The system of claim 16, wherein the one or more processors are further configured to perform operations comprising modifying a ranking of an image determined to be a click magnet image to decrease the image's ranking relative to other images for search queries having a category that does not belong to the set of categories.

26. The system of claim 16, wherein each category of the proper subset of categories is a category identified as being a click magnet seeking category.

27. The system of claim 16, wherein determining that the image is a click magnet image based at least in part on the first number of selections and the total number of selections comprises:
determining a ratio of the first number of selections to a second number of selections, the second number of selections being selections of image search results that included a representation of the image for search queries categorized as belonging to a second subset of categories, each category of the second subset of categories being different than each category of the proper subset of categories;
determining that the ratio satisfies a threshold; and
in response to determining that the ratio satisfies the threshold, determining that the image is a click magnet image.

28. A computer storage medium encoded with a computer program, the program comprising instructions that when executed by data processing apparatus cause the data processing apparatus to perform operations comprising:
obtaining, for each of a plurality of images, a selection vector for the image, the selection vector including a plurality of vector elements, each vector element corresponding to a unique search query, and the value of each vector element being proportional to a number of selections of image search results that included a representation of the image when the search results were presented in response to the unique search query;
identifying a category for each search query of each selection vector, each category for a search query belonging to a set of categories;
for each image:
determining a first number of selections of image search results that included a representation of the image for search queries categorized as belonging to a proper subset of the set of categories;
determining a total number of selections of image search results that included a representation of the image; and
determining that the image is a click magnet image based at least in part on the first number of selections and the total number of selections.
